(19) United States
(12) Patent Application Publication
(10) Pub. No.: US 2007/0115265 A1
(43) Pub. Date: May 24, 2007

(54) Mobile device and method

(75) Inventor: Roope Rainisto, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/284,695

(22) Filed: Nov. 21, 2005

(51) Int. Cl. G09G 5/00

(52) U.S. Cl. 345/173

(57) ABSTRACT

A method of controlling a mobile communication terminal comprises the steps of sensing (201) a touch on a touch sensitive display, determining (203) a type of implement having provided the sensed touch on the touch sensitive display, where the type of implement is one of at least a blunt type and a pointed type. Depending on the determined type of implement, user interface elements of a first spatial configuration are displayed (207) when the determined type of implement is the pointed type and user interface elements of a second spatial configuration are displayed (209) when the determined type of implement is the blunt type.

### FIELD OF THE INVENTION

The present invention relates to a method for controlling a mobile communication terminal, a mobile communication terminal and a computer program performing such a method. Specifically, the invention relates to facilitating user input using a touch sensitive display.

### BACKGROUND

Present day mobile devices such as mobile phones are often equipped with display screens that are combined with a transparent touch sensitive layer. Such an arrangement, which typically is referred to as a touch sensitive display, is typically configured to receive input by interaction with a user through a user interface, both by use of a dedicated pointer device (often referred to as a stylus) or simply by the user tapping the screen with a finger tip.

Needless to say, a stylus and a finger are quite different pointer devices. The tip of a stylus is smaller and lighter and it allows for more precise input than a human finger. The finger is larger and heavier and does not allow for very precise input, at least in terms of spatial resolution. On the other hand, the finger is always immediately available whereas the stylus typically is required to be extracted from a storage arrangement within or attached to the mobile device and, after being used, replaced in the storage arrangement.

Although it is possible to design and realize a user interface that is suited for either the stylus or the finger, a problem arises due to their incompatibility. That is, the use of a mobile device, such as a cellular telephone, involves a number of different short-term and longer term tasks. Some tasks require only one or two actions by the user, i.e. “taps” on the touch sensitive display, by the user and some tasks require several minutes and dozens of “taps” or “clicks”. Hence, any prior art user interface that is suited to accommodate use by either the stylus or the finger is necessarily a compromise in this regard. This is particularly accentuated when considering small mobile devices having very small display screens, where a compromise is unavoidable regarding the size of displayed user interface elements and the number of displayed user interface elements. Furthermore, requiring the user to “take out the stylus” to provide input via the user interface in order to have the device performing a specific functionality is typically also a major burden, both in the sense that it is time consuming and often quite impractical for the user.

When designing mobile devices that support an “always-on” mode and instant use mode, designing for finger input instead of stylus use is a good principle. On the other hand, the functionality for providing the additional precision of stylus use should nevertheless be supported in order to provide a desired flexibility from the viewpoint of the user.

Ways to bridge the gap between stylus and finger user interface functionality is hence desirable, so that one single user interface would suit both types of functionality properly. Attempts to bridge such a gap have been made by providing designs of user interfaces that are compromises in that they, e.g., support stylus input and provide separate hardware keys that allow selection of user interface elements without tapping the screen, or by providing designs for finger input (the Myorigo device for example) or by allowing the user to scale and zoom the user interface elements as desired.

### SUMMARY OF THE INVENTION

An object of the invention is to overcome at least some of the drawbacks relating to the compromise designs of prior art devices as discussed above.

Hence, in a first aspect there is provided a method for controlling a mobile communication terminal comprising a touch sensitive display. The method comprises the steps of sensing a touch on the touch sensitive display, determining a type of implement having provided the sensed touch on the touch sensitive display, where the type of implement is one of at least a blunt type and a pointed type. Depending on the determined type of implement, user interface elements of a first spatial configuration are displayed when the determined type of implement is the pointed type and user interface elements of a second spatial configuration are displayed when the determined type of implement is the blunt type.

The first and second spatial configurations may correspond to a respective first and second spatial scale, wherein the first spatial scale is smaller than the second spatial scale. The first and second spatial configurations may also correspond to a respective first and second spatial distribution of user interface elements. The first and second spatial distribution may also comprise a respective first and second number of elements and wherein the first number of elements is larger than the second number of elements.

The sensing of a touch may involve providing touch information in the form of at least mechanical pressure information and also involve providing touch information in the form of at least electric resistance information. The touch sensing may also involve providing touch information comprising information regarding spatial distribution of the touch information.

Hence, the word “touch” is intended to encompass a general concept of being able to determine whether the input is done with a pointed stylus type of implement or a more blunt implement, such as a human finger, and the way of sensing the touch information may differ with technical implementation. Pressure information, electric resistance as well as the spatial distribution, e.g. the size, of the implement used by the user to touch the display may be used and/or a combination of these may be used in combination to determine the “touch”. An example of how to combine pressure information and spatial distribution is by multiplying sensed pressure with an area over which the pressure is sensed.

In other words, the control circuitry of the terminal is configured (i.e. programmed using software components) in such a way that it generates information of a touch on the touch sensitive display in the form of a type of implement used, which indicates whether the tap was done with a pointed implement such as a stylus or with a blunt implement, such as a finger tip. Typically, during touch sensing, the circuitry will also sense at which position on the display the touch was made. Such information, although typically very useful, is not essential for the invention at hand.

After the sensing of a touch, it is determined that one action is to be performed when the tapping is sensed to have been performed with a pointed implement such as a stylus and another action with when a blunt implement, such as a finger tip, has been used when tapping on the display. The action (view, dialog etc.) in the user interface that is performed when tapping with a stylus has been determined is designed for stylus use, and the action (view, dialog etc.) that is performed when tapping with a finger tip is then designed for finger tip use. For example, the configuration of the user interface elements may change in terms of different spatial scales and different number of elements that are displayed. The elements may vary in size and their locations may vary. Moreover, a plurality of elements may be grouped together and configured such that, e.g. in a case with input keys, one single displayed key is associated with the group of keys.

In summary, a user interface style is achieved that provides the user interface with flexibility based on whether the user is currently tapping the screen with a pointed implement, such as a stylus, or a blunt implement, such as a finger, without requiring any separate user setting or mode switching between stylus and finger user interface modes. Hence, information regarding the manner in which the display has been touched is utilized and user interface functionality is provided that supports both stylus and finger use without a need to specify separate modes of operation in one and the same device. This is advantageous in a number of ways, including the fact that it is usable in a wide range of user interface situations, it is totally modeless, i.e. there is no need to user to switch between stylus and finger modes, and it is totally transparent, i.e. there is no need to provide an on-screen or hardware control to switch between modes. The invention makes the terminal stylus-independent in that there is no need for a dedicated stylus having a certain mechanical system to distinguish between stylus and finger use (In fact, some already existing styluses use for instance a magnet/electrical element in the tip of the stylus that the display circuitry then detects and interacts with.).

In other aspects, the invention provides a system and a computer program having features and advantages corresponding to those discussed above.

### BRIEF DESCRIPTION OF THE DRAWINGS

Having thus described the invention in general terms, reference will now be made to the accompanying drawings, which are not necessarily drawn to scale, and wherein:

FIG. 1 shows schematically a block diagram of a communication terminal according to one embodiment of the present invention.

FIG. 2 is a flow chart illustrating a number of steps of a method according to one embodiment of the present invention.

FIGS. 3a-c illustrate the appearance of user interface elements on a display of a terminal during operation of the method of FIG. 2.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

FIG. 1 illustrates schematically a communication terminal 101 in which an embodiment of the present invention is implemented. The terminal 101 is capable of communication via an air interface 103 with a radio communication system 105 such as the well known systems GSM/GPRS, UMTS, CDMA 2000, etc. The terminal comprises a processor 107, memory 109 as well as input/output units in the form of a microphone 111, a speaker 113, a touch sensitive display 115 and a keyboard 117. The touch sensitive display 115 comprises appropriate touch sensing means, such as electronic sensing circuitry 116, configured to sense touch by way of, e.g., a pointed stylus as well as a finger tip. The circuitry 116 may be configured to sense variations in any one or more of mechanical pressure, electric resistance and spatial distribution of the touch. In this regard, actuation of a touch sensitive display 115 with a pointed implement generally provides more mechanical pressure, less electrical resistance and less spatial distribution than actuation by a blunt implement under the same actuation conditions. Radio communication is realized by radio circuitry 119 and an antenna 121. The details regarding how these units communicate are known to the skilled person and are therefore not discussed further.

The communication terminal 101 may for example be a mobile telephone terminal or a PDA equipped with radio communication means. The method according to the present invention will in general reside in the form of software instructions, together with other software components necessary for the operation of the terminal 101, in the memory 109 of the terminal. Any type of conventional removable memory is possible, such as a diskette, a hard drive, a semi-permanent storage chip such as a flash memory card or “memory stick” etc. The software instructions of the inventive notification function may be provided into the memory 109 in a number of ways, including distribution via the network 105 from a software supplier 123. That is, the program code of the invention may also be considered as a form of transmitted signal, such as a stream of data communicated via the Internet or any other type of communication network, including cellular radio communication networks of any kind, such as GSM/GPRS, UMTS, CDMA 2000 etc.

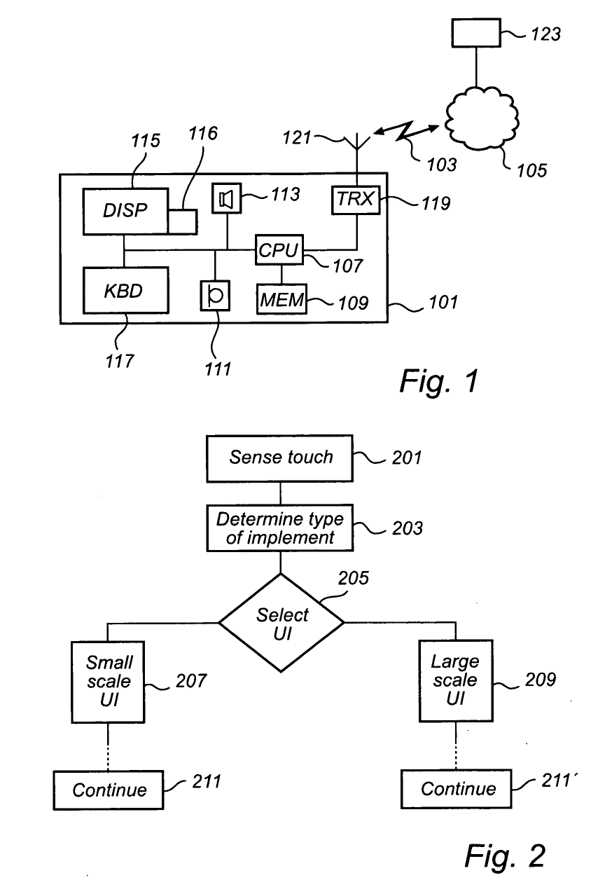

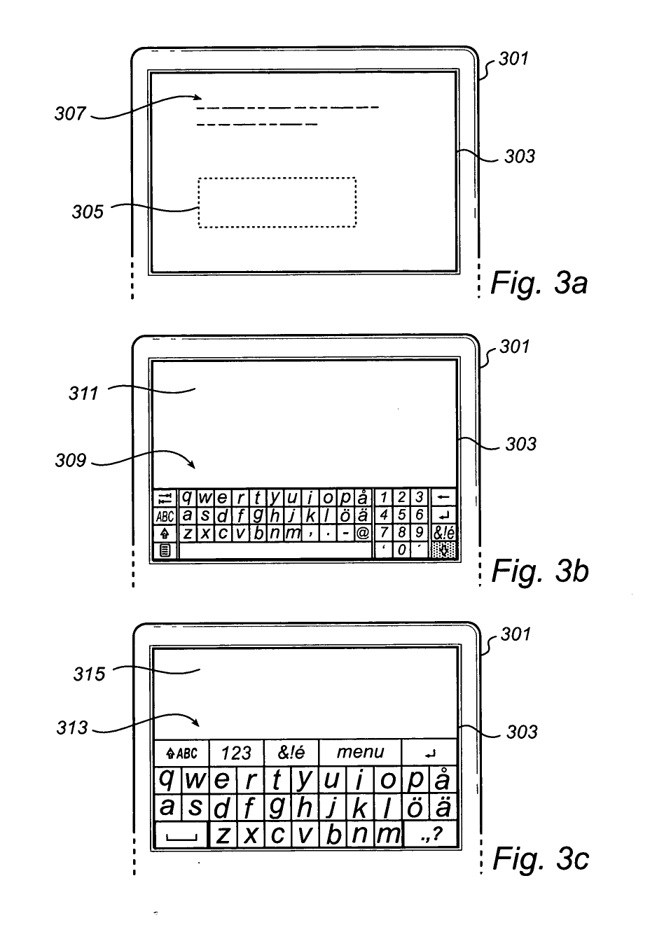

Turning now to FIGS. 2 and 3a-c, a method according to one embodiment of the invention will be described in terms of a number of steps to be taken by controlling software in a terminal such as the terminal 101 described above in connection with FIG. 1.

The exemplifying method starts at a point in time when a user interface element in the form of an input text field 305 is displayed on a touch sensitive display 303 of a terminal 301. As the skilled person will realize, any amount of displayed information may also be present on the display 303 as indicated by schematically illustrated dummy content 307.

A touch action, e.g. tapping, performed by a user on the input text field 305 is sensed in a sensing step 201. The sensing is realized, as discussed above, in a touch sensing means, such as sensing circuitry connected to the display 301 (cf. sensing circuitry 116 in FIG. 1).

In a determination step 203, a type of implement used by the user when performing-the sensed touch is determined. Here, two types of implements are distinguished: a pointed implement, such as a stylus, and a more blunt implement, such as a finger tip. As used herein, a pointed implement need not necessarily include a distal end that is perfectly pointed, and the blunt implement need not include a distal end that is completely blunt. Instead, the pointed implement is merely more pointed than the blunt implement, and the blunt implement is more blunt than the pointed implement. The determination of the type of implement is typically performed by determining means that is generally implemented by computer instructions stored in a memory device, such as memory 109, and executed by processor 107.

In a selection step 205, the determined type of implement is used to select between two alternatives for presenting subsequent user interface elements on the display 303. Like the determining means, the selection of the manner of presentation of the user interface elements is typically performed by control means that is generally implemented by computer instructions stored in a memory device, such as memory 109, and executed by processor 107.

In a case where the type of implement is determined to be a pointed implement, such as a stylus, a user interface having elements of a spatially small scale is displayed in a display step 207. This is illustrated in FIG. 3b where user interface elements in the form of a keyboard 309 is displayed having a small spatial scale and comprising a large number of individual user interface elements (i.e. keypad keys). A text output field 311 is also indicated in which any subsequent user input (i.e. results due to tapping on the displayed keyboard 309) is to be displayed during a continuation as indicated by reference numeral 211.

In a case where the type of implement is determined in the determination step 203 to be a blunt implement such as a finger tip, a user interface having elements of a spatially large scale is displayed in a display step 209. This is illustrated in FIG. 3c where user interface elements in the form of a keyboard 313 is displayed having a large spatial scale and comprising a smaller number of individual user interface elements (i.e. keypad keys), in comparison with the case of a small scale user interface. As used herein, large and small spatial scales are relative terms with the large spatial scale merely being larger than the small spatial scale. A text output field 315 is also indicated in which any subsequent user input (i.e. results due to tapping on the displayed keyboard 323) is to be displayed during a continuation as indicated by reference numeral 211′.

Although the example above only shows user interface elements in the form of keyboard keys having different spatial scales and different locations on the display 303, other elements are also possible, such as user interface elements in the forms of scroll bars, editing windows, dialog boxes etc. Moreover, a plurality of elements may be grouped together and configured such that, e.g. in a case with input keys, one single displayed key is associated with the group of keys.

In addition to or instead of displaying the user interface elements in accordance with larger and smaller scales in response to detecting actuation by blunt and pointed implements, respectively, the user interface can display the user interface elements in accordance with various other spatial configurations depending upon the type of implement with spatial configurations that require more precise input being provided in response to the detection of a pointed implement and spatial configurations that have greater tolerance in terms of the acceptable input being provided in response to the detection of a blunt implementation. For example, the user interface can display user interface elements in accordance with different spatial distributions with the spatial distribution resulting from the detection of a pointed implement being less such that the user interface elements are positioned more closely to the neighboring user interface elements than the spatial distribution resulting from the detection of a blunt implement in which the spatial distribution is greater such that the user interface elements are more widely spaced apart from one another.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method for controlling a mobile communication terminal comprising a touch sensitive display, the method comprising the steps of:
sensing a touch on the touch sensitive display,
determining a type of implement having provided the sensed touch on the touch sensitive display, said type of implement being one of at least a blunt type and a pointed type, and
depending on the determined type of implement, displaying user interface elements of a first spatial configuration when the determined type of implement is the pointed type and displaying user interface elements of a second spatial configuration when the determined type of implement is the blunt type.

2. The method according to claim 1, wherein the first and second spatial configurations correspond to a respective first and second spatial scale and wherein the first spatial scale is smaller than the second spatial scale.

3. The method according to claim 1, wherein the first and second spatial configurations correspond to a respective first and second spatial distribution of user interface elements.

4. The method according to claim 1, wherein the first and second spatial distribution comprises a respective first and second number of elements and wherein the first number of elements is larger than the second number of elements.

5. The method according to claim 1, wherein the step of sensing a touch involves providing touch information in the form of at least mechanical pressure information.

6. The method according to claim 1, wherein the step of sensing a touch involves providing touch information in the form of at least electric resistance information.

7. The method according to claim 5, wherein the step of sensing a touch involves providing touch information comprising information regarding spatial distribution of the touch information.

8. A mobile communication terminal comprising a touch sensitive display and:
touch sensing means for sensing a touch on the touch sensitive display,
determining means for determining a type of implement having provided the sensed touch on the touch sensitive display, said type of implement being one of at least a blunt type and a pointed type, and
control means configured for, depending on the determined type of implement, displaying user interface elements of a first spatial configuration when the determined type of implement is the pointed type and displaying user interface elements of a second spatial configuration when the determined type of implement is the blunt type.

9. The terminal according to claim 8, wherein the first and second spatial configurations correspond to a respective first and second spatial scale and wherein the first spatial scale is smaller than the second spatial scale.

10. The terminal according to claim 8, wherein the first and second spatial configurations correspond to a respective first and second spatial distribution of user interface elements.

11. The terminal according to claim 8, wherein the first and second spatial distribution comprises a respective first and second number of elements and wherein the first number of elements is larger than the second number of elements.

12. The terminal according to claim 8, wherein the touch sensing means comprises means for providing touch information in the form of at least mechanical pressure information.

13. The terminal according to claim 8, wherein the touch sensing means comprises means for providing touch information in the form of at least electric resistance information.

14. The terminal according to claim 12, wherein the touch sensing means comprises means for providing touch information comprising information regarding spatial distribution of the touch information.

15. A computer program product comprising a computer readable medium having computer readable software instructions embodied therein, wherein the computer readable software instructions comprise:
computer readable software instructions capable of sensing a touch on the touch sensitive display,
computer readable software instructions capable of determining a type of implement having provided the sensed touch on the touch sensitive display, said type of implement being one of at least a blunt type and a pointed type, and
computer readable software instructions capable of, depending on the determined type of implement, displaying user interface elements of a first spatial configuration when the determined type of implement is the pointed type and displaying user interface elements of a second spatial configuration when the determined type of implement is the blunt type.

16. The computer program product according to claim 15, wherein the first and second spatial configurations correspond to a respective first and second spatial scale and wherein the first spatial scale is smaller than the second spatial scale.

17. The computer program product according to claim 15, wherein the first and second spatial configurations correspond to a respective first and second spatial distribution of user interface elements.

18. The computer program product according to claim 15, wherein the first and second spatial distribution comprises a respective first and second number of elements and wherein the first number of elements is larger than the second number of elements.

19. The computer program product according to claim 15, wherein the computer readable software instructions that are capable of sensing a touch are further capable of providing touch information in the form of at least one of mechanical pressure information, electric resistance information and spatial distribution of touch information.
